(19) United States
(12) Patent Application Publication
(10) Pub. No.: US 2008/0247509 A1
(43) Pub. Date: Oct. 9, 2008

(54) RADIATION IMAGE OBTAINING SYSTEM

(75) Inventor: Nobuhiko KASHIWAGI, Ashigarakami-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/098,767

(22) Filed: Apr. 7, 2008

(30) Foreign Application Priority Data
Apr. 5, 2007 (JP) 099382/2007

(51) Int. Cl. G01B 15/02

(52) U.S. Cl. 378/54

(57) ABSTRACT

(Problem) To obtain radiation images providing a tomogram which is higher in quality.

(Means for Solving the Problem) Thickness of the object is detected and the amount of radiation projected in the projecting directions so that the amount of radiation entering the radiation image detector is uniform according to the projecting direction and the thickness of the object.

### BACKGROUND OF THE INVENTION

1. Field of the Invention

This invention relates to a radiation image obtaining system for obtaining a tomogram by a radiation image taking.

2. Description of the Related Art

Recently, there has been proposed a tomosynthesis in a x-ray system (CR: computed radiography) where an object is x-rayed from different angles by moving the x-ray tube while the object is exposed to x-rays in order to observe the diseased part in more detail and the obtained images are added to obtain an image where a desired cross-section is emphasized.

In the tomosynthesis, the x-ray tube is moved in parallel to the sensor such as a flat panel or to move along the segment of a circle or an ellipse, in order to project x-rays in a predetermined amount onto an object from different angles to obtain a plurality of radiation images and the radiation images are rearranged into a tomogram. As disclosed, for instance, in Japanese Unexamined Patent Publication Nos. 2003-305031 and 2004-188200, a tomogram can be obtained by adding a plurality of radiation images after movement in parallel to each other and/or adjustment in the sizes of the images.

When the same amount of radiation as the simple x-ray photographing is projected onto an object each time the x-ray is projected onto the object for the tomosynthesis, the object is exposed to too much x-rays and the amount of the x-rays projected onto the object per one projection is reduced as the number of the projecting times is increased.

However, when the object is photographed at different projecting angles the density of the photographed images are different from each other even if x-rays are projected onto the object in a predetermined amount due to the difference in distance over which the radiation passes through the object. Since the amount of the x-rays projected onto the object per one projection is reduced due to that the object is photographed a plurality of times, the influence of the difference in distance over which the radiation passes through the object largely appears, and the tomogram obtained by adding the radiation images cannot be free from the influence.

### SUMMARY OF THE INVENTION

In view of the foregoing observations and description, the primary object of the present is to provide a radiation image obtaining system providing a tomogram which is better in quality in the tomosynthesis.

The radiation tomogram obtaining system of the present invention comprises

a radiation image detector which detects a radiation image of an object,

a radiation projecting means which is provided to be opposed to the radiation image detector, and to project radiation in a plurality of projecting directions onto the object on the radiation image detector while moving,

a thickness detecting means which detects the thickness of the object,

a radiation amount control means which controls the amount of radiation projected in each of the projecting directions so that the amount of radiation entering the radiation image detector is uniform according to the projecting direction and the thickness of the object.

The radiation tomogram obtaining system of the present invention may further comprise a radiation amount detecting means which detects the amount of radiation projected by the radiation projecting means and passed through the object and

the radiation amount control means may control the amount of radiation projected in each of the projecting directions on the basis of the amount of radiation projected by the radiation projecting means in a reference direction, the amount of radiation detected by the radiation amount detecting means when the radiation projecting means projects radiation in the reference direction, and the angle between the reference direction and each of the projecting directions.

In accordance with the present invention, quality of the tomogram generated from the radiation images obtained in the tomosynthesis can be improved by controlling so that the amount of radiation entering the radiation image detector is uniform according to the projecting direction of the radiation and the object when a tomosynthesis photographing is carried out.

The tomosynthesis photographing can be constantly carried out in a suitable amount of radiation irrespective of the object by controlling the amount of radiation to be projected from the radiation projecting means according to the amount of radiation attenuated by the object corresponding to the amount of radiation projected from the radiation projecting means in the reference direction minus the amount of radiation passing through the object.

### BRIEF DESCRIPTION OF THE DRAWINGS

FIG. 1 is a view showing a radiation tomogram obtaining system,

FIG. 2 is a front view of a part of an arm of a mammography,

FIG. 3 is a front view showing a rotation of a part of an arm of a mammography,

FIG. 4 is a view showing the pressure plate and the relation between the solid detector and the radiation amount detector in the photographing table,

FIG. 5 is a view showing a radiation image obtaining system for the mamma,

FIG. 6 is a view showing a radiation image detector (solid detector),

FIG. 7 is a view showing a connection between the radiation image detector and a current detecting means,

FIG. 8 is a view showing detail of the current detecting means and a high voltage power supply means and connection between these means and the solid detector,

FIG. 9 is a view showing the relation between the attenuation of the radiation and the projecting direction from the radiation source,

FIG. 10 is a view showing the attenuation of the radiation reaching the radiation image detector,

FIG. 11 is a view showing a radiation image generating system,

FIG. 12 is a view for describing a method of rearranging a tomogram from the radiation images,

FIG. 13 is a view showing inclinations of the photographing table, and the positions of the mamma, and

FIG. 14 is a view showing the relation between the photographing angle and the photographing interval.

### PREFERRED EMBODIMENT OF THE INVENTION

A first embodiment of the present invention will be described with reference to the drawings, hereinbelow. In this embodiment, a radiation image obtaining system where a mamma in a pressurized state is photographed in the tomosynthesis by providing a function of tomosynthesis to a mamma image taking system where a mamma is placed on a photographing table and pressurized by a pressure plate and is photographed in this state will be described.

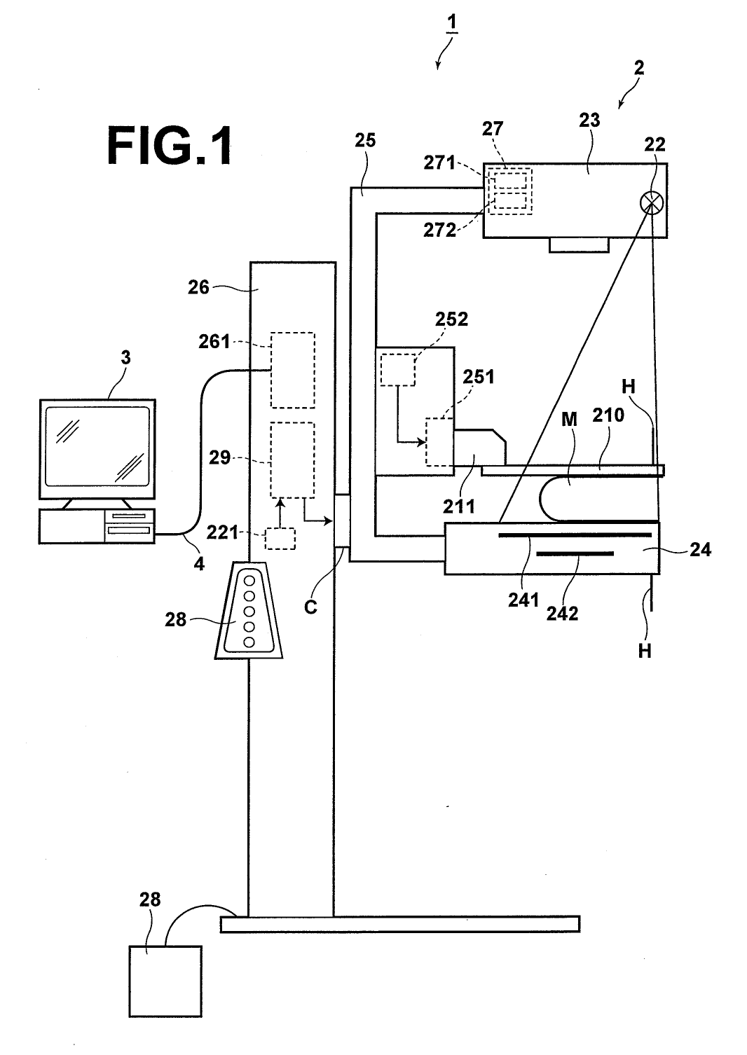

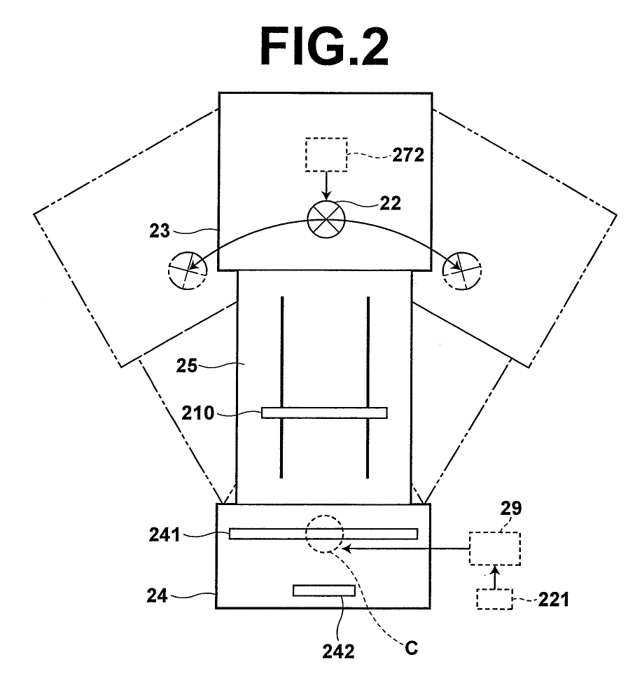

FIG. 1 is a view showing a radiation tomogram obtaining system of the present invention, and FIG. 2 is a front view of a part of an arm of a mammography forming the radiation tomogram obtaining system.

The radiation tomogram obtaining system 1 comprises a mamma image taking system 2 which projects radiation in different directions onto a mamma M of an object and obtains a plurality of images of the mamma M, a tomogram generating system 3 which rearranges images of the mamma M obtained by the mamma image taking system 2 to generate a tomogram and a network 4 connecting the mamma image taking system 2 and the tomogram generating system 3.

The mamma image taking system 2 comprises a radiation containing portion 23 which contains therein a radiation projecting portion (to be referred to as “the radiation source”) 22, a photographing table 24 which contains therein a radiation image detector 241 such as a flat panel detector, an arm 25 which connects the radiation containing portion 23 and the photographing table 24 to be opposed to each other, a base 26 which mounts the arm 25 by the shaft C, a radiation source control portion 27 which controls projection of radiation from the radiation source 22 and a transmitting portion 261 which transmits data such as a radiation image to the tomogram generating system 3 by way of the network 4.

A control portion 28 through which the operator adjusts the height, rotation and/or the direction of the arm 25 and an arm moving means 29 which moves up and down and rotates the arm 25 according to the input from the control portion 28 are further provided on the base 26.

The arm 25 is provided between the radiation containing portion 23 and the photographing table 24 with a mounting portion 251 through which a pressure plate 210 is mounted to press the mamma M of the object and a pressure plate moving means 252 which moves up and down the mounting portion 251 along the arm 25.

The pressure plate 210 is provided with an insertion portion 211 for inserting into the mounting portion 251 of the arm 25.

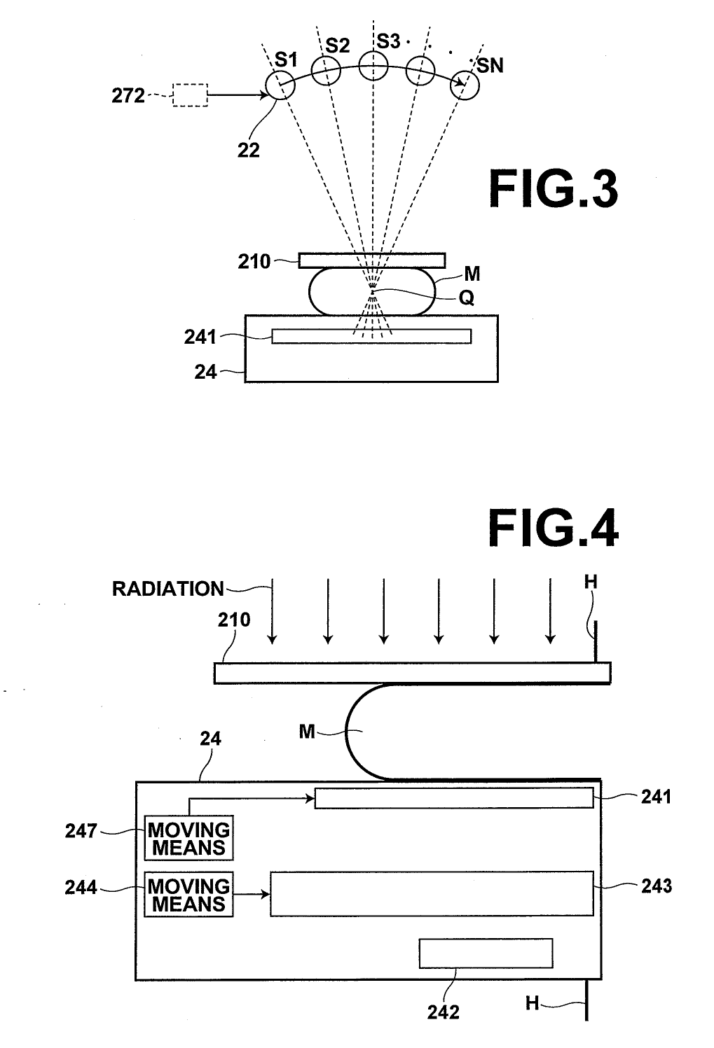

The radiation source 22 is contained in the radiation containing portion 23, and a radiation source moving means 221 is operated to control the arm moving means 29 to rotate the radiation containing portion 23 about the shaft C as shown in FIG. 2 to the radiation source 22 in the direction along a side opposite to a breast wall H of the object on the photographing table 24 (normally toward the longer side of the photographing table 24 which is rectangular). See FIG. 3.

The radiation source 22 projects radiation onto the mamma M on the photographing table 24 in each of projecting positions S1, S2, . . . , SN in different projecting directions while being arcuately moved. When the mamma M is photographed, the thickness of the mamma M is about 4 to 5 cm since the mamma M is placed on the photographing table 24 and pressed by the pressure plate 210 from above. Accordingly, in order to obtain an image facilitating observation of the mamma M, it is preferred that the radiation source 22 projects the radiation toward a point Q (referred to as “the projecting point”, hereinbelow.) higher than the central point (specifically, a point corresponding to the central point of the mamma M when the mamma M is placed on the photographing table 24) of the photographing plane on the photographing table 24 by about 2 cm in each of the projecting positions.

Inside the photographing table 24, there is disposed, as shown in FIG. 2, a flat panel detector 241 which receives projection of radiation to record a radiation image according to the amount of radiation passing through the mamma M and outputs the recorded radiation image and there is disposed under the flat panel detector 241 a radiation amount detecting means 242 which detects the amount of radiation projected by the radiation containing portion 23 and passed through the mamma M.

Further, the shaft C which forms a center of rotation is mounted on the center of the flat panel detector 241 so that the arm 25 rotates about the shaft C and the arm 25 is mounted on the base 26 (See FIG. 2).

In this embodiment, the photographing table 24 in the case where the radiation image detector 241 is a flat panel detector will be described with reference to FIGS. 4 to 7, hereinbelow.

Inside the photographing table 24, there are disposed, as shown in FIG. 4, a reading light source 243 which is used when the image information recorded on the radiation image detector 241 is to be read, a reading light source moving means 244 which moves the reading light source 243 in a sub-scanning direction, a current detecting means 245 which detects a current flowing out from the radiation image detector 241 when the radiation image detector 241 is scanned and exposed by the reading light source 243, a high voltage power source 246 which applies a predetermined voltage to the radiation image detector 241, a before-exposure light source 260 which projects before-exposure light to the radiation image detector 241 before starting the photographing, the radiation image detector moving means 247 which moves the radiation image detector 241 toward and away (the aforesaid sub-scanning direction) from the breast wall H in the photographing table 24, and a control means 248 which controls the reading light source 243, current detecting means 245, high voltage power source 246, before-exposure light source 260, and the moving means 247 and 244.

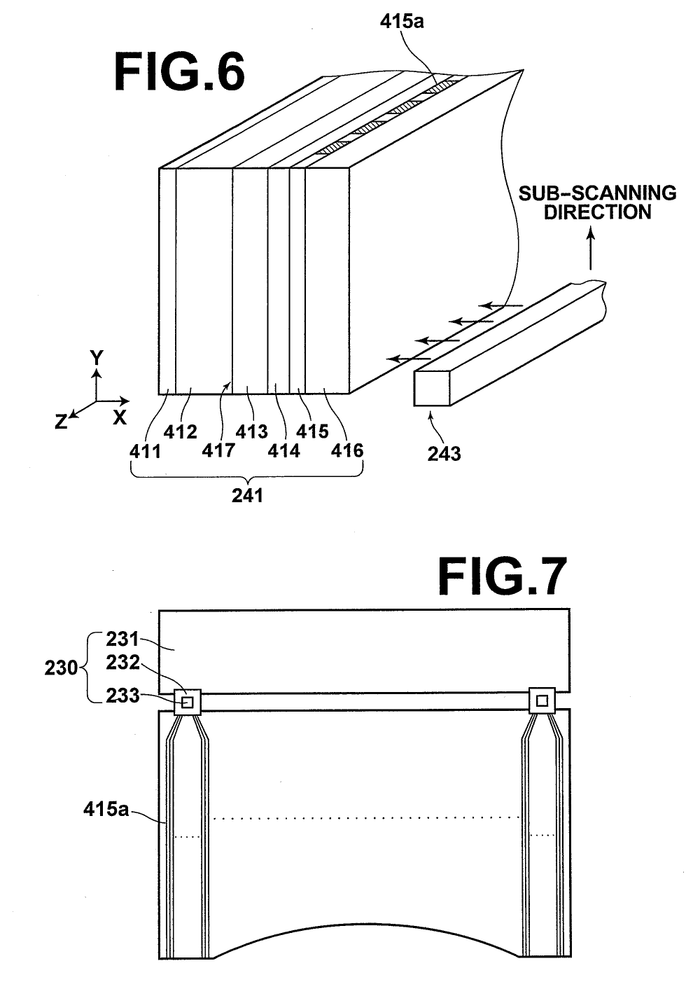

The radiation image detector 241 is a solid sensor of a direct conversion system and an optical reading system and stores image information as an electrostatic latent image in response to exposure to recording light carrying thereon the image information and generates a current according to the electrostatic latent image in response to being scanned by reading light. Specifically, as shown in FIG. 6, the radiation image detector 241 comprises a first conductive layer 411 which transmits the radiation passed through the mamma M, a recording photoconductive layer 412 which generates an electric charge and exhibits a conductivity in response to exposure to recording light, a charge transfer layer 413 which substantially acts as an insulating body to a latent image charge to which the first conductive layer 411 is charged and substantially acts as a conductive body to a transfer charge opposite to the latent image charge in polarity, a reading photoconductive layer 414 which generates an electric charge and exhibits a conductivity in response to exposure to reading light, and a second conductive layer 415 which transmits a reading radiation formed on a glass substrate 416 in this order. A charge storing portion 417 is formed on an interface between the recording photoconductive layer 412 and the charge transfer layer 413.

The first and second conductive layers 411 and 415 respectively form electrodes and the first conductive layer 411 is two-dimensional and flat while the second conductive layer 415 is a stripe electrode having a number of elements (linear electrodes) 415a arranged at pixel pitches. For example, see an electrostatic recording medium disclosed in Japanese Unexamined Patent Publication No. 2000-105297). The direction in which the elements 415a is arranged corresponds to the main scanning direction while the longitudinal direction of the elements 415a corresponds to the sub-scanning direction.

The size of the solid detector 241 is 30 cm×24 cm to conform to a large mamma M and the solid detector 241 is contained in the photographing table 24 so that the longer side is in the main scanning direction and the shorter side is in the sub-scanning direction.

The reading light source 243 comprises a line source comprising a plurality of LED chips arranged in a row, and an optical system which projects light output from the line source onto the solid detector 241 in a line. Further, a moving means 244 comprising a linear motor scans the reading light source 243 in the longitudinal direction of the stripe electrode 415a of the solid detector 241, or the sub-scanning direction, thereby exposing the entire area of the solid detector 241. Further, the reading light source 243 and the moving means 244 form a reading light scanning means.

FIG. 7 shows a connection between the solid detector 241 and a current detecting means 245. As shown in FIG. 7, each element 415a of the solid detector 241 is connected to a charge amplifier IC 233 by way of a printed pattern (not shown) formed on TAB (tape automated bonding) film 232 on the side in contact with the breast wall H of an examinee and the charge amplifier IC 233 is connected to a printed-circuit board 231 by way of a printed pattern (not shown) formed on TAB film 232. In this embodiment, not all the elements 415a are connected to one charge amplifier IC 233, but several to several tens of charge amplifier ICs 233 are provided in the whole, and about several to a hundred of the elements 415a adjacent to each other in sequence are connected to each of the charge amplifier ICs 233.

The current detecting means 245 need not be limited to that shown in above embodiment but may be of a so-called COG (chip on glass) type where the charge amplifier IC 233 is formed on the glass substrate not on the TAB film.

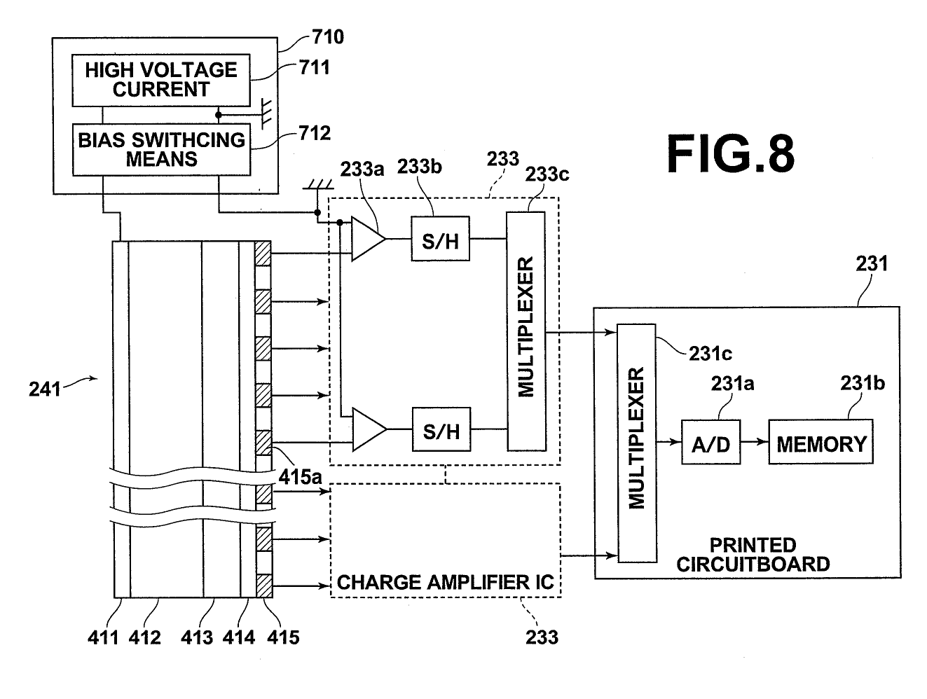

FIG. 8 is a block diagram showing detail of the current detecting means 245 and a high voltage power supply means 710 provided in the photographing table 24 and connection between these means and the solid detector 241.

The high voltage power supply means 710 comprises a high voltage power supply 711 and a bias switching means 712 integrated with each other and the high voltage power supply 711 is connected to the electrostatic recording portion 241 by way of the bias switching means 712 for switching imparting a bias and short-circuiting. This circuit is designed to prevent generation of the charging and discharging excessive current in order to prevent the place of the system where the current is accumulated from being damaged by limiting the peak-to-peak value, which flows upon switching.

Each of the charge amplifier IC 233 formed on the TAB film comprises a number of charge amplifier 233a connected to each of the elements 415a of the solid detector 241, a sample hold (S/H) 233b and a multiplexer 233c which multiplexes the signals from each of the sample holds 233b. The current flowing out the solid detector 241 is converted to a voltage by each charge amplifier 233a, the voltage is sample-held at a predetermined timing by the sample hold 233b and the sample-held voltage corresponding to each of the elements 415a is output by the multiplexer 233c in sequence to be switched in the order of the elements 415a (corresponding to a part of the main scanning). The signals output from the multiplexer 233c in sequence are input into a multiplexer 231c which is formed in the printed-circuit board 231 and are output from the multiplexer 231c in sequence so that the voltages corresponding to the elements 415a are switched in sequence in the order of the elements 415a, and the main scanning is ended. The signals output from the multiplexer 231c in sequence are converted into digital signals by an A/D converter 231a and the digital signals are stored in a memory 231b.

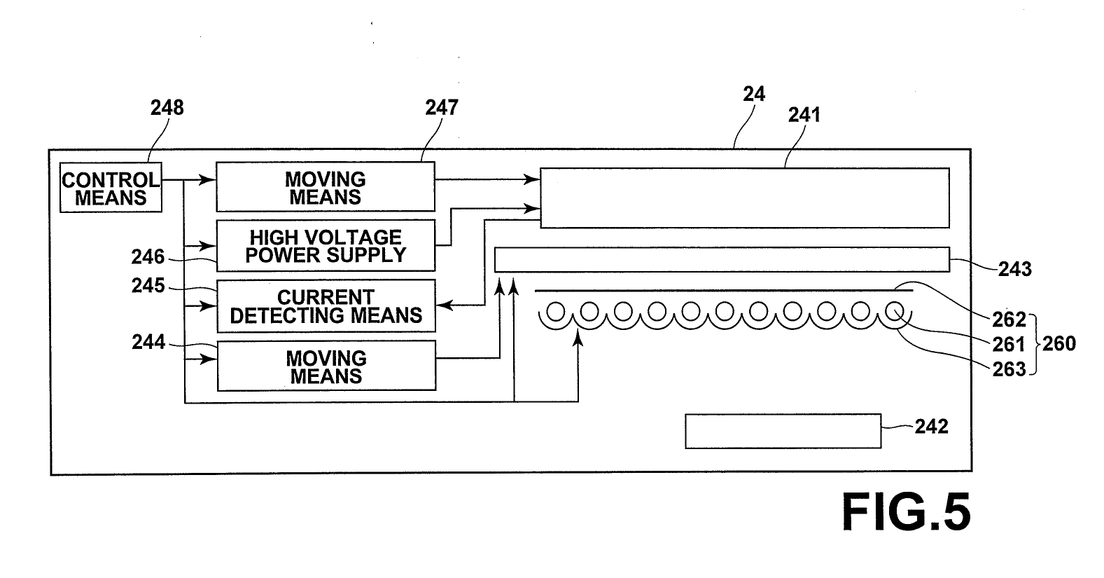

As the before-exposure light source 260, it is necessary to emit light and extinct in a short time and to be very small in afterglow. For this purpose, in this embodiment, an external electrode type rare gas fluorescent lamp is used. In more detail, as shown in FIG. 5, the before-exposure light source 260 comprises a plurality of external electrode type rare gas fluorescent lamps 261 extending in the direction of depth of the paper in which FIG. 5 is depicted, a wavelength selective filter 262 inserted between the fluorescent lamps 261 and the solid detector 241, and a reflecting plate 263 which is disposed behind the fluorescent lamps 261 to reflect light emitted from the fluorescent lamps 261 efficiently toward the solid detector 241. Though the before-exposure light may be reflected to the whole second conductive layer 415 of the solid detector 241 and it is not necessary a particular light accumulating means, it is preferred that the illuminance distribution be smaller.

Two-dimensionally arranged LED chips may be used as the light source instead of the fluorescent lamps 261.

The moving means 247 comprises for instance a linear motor (not shown) and moves in parallel the solid detector 241 back and forth between a photographing position and a reading position.

Other than the solid detector 241 described above, the flat panel detector may be of a TFT system which can read out the signal charges stored in the charge storing portion of solid detecting elements by driving the TFT connected to the charge storing portion (See, for instance, Japanese Unexamined Patent Publication Nos. 2004-080749 and 2004-073256.)

The radiation amount detecting means 242 is disposed below the flat panel detector 241 and detects the amount of radiation entering the flat panel detector 241. As the radiation amount detecting means 242, for instance, an AEC sensor provided with a semi-conductor detector which detects the amount of radiation projected onto the flat panel detector 241. Otherwise, it may be detected through the amount of radiation projected onto the flat panel detector 241. In this embodiment, description will be made on the basis of the assumption that the radiation amount detecting means 242 is an AEC sensor.

The radiation source control portion 27 comprises a thickness detecting means 271 which detects the thickness of the mamma M, and the radiation projection amount control means 272 which controls for instance, the tube voltage and/or the tube current, thereby controlling the amount of projected radiation.

The thickness detecting means 271 detects the thickness of the mamma M on the basis of the position of the mamma M when the pressure plate moving means 252 is driven to press the mamma M by the pressure plate 210. Otherwise, the thickness detecting means 271 may receive and use the thickness of the mamma M measured by the operator and input though the control panel or the like.

The radiation projection amount control means 272 controls the amount of projected radiation by controlling, for instance, the tube voltage and/or the tube current so that a constant amount of radiation enters the flat panel detector 241 according to the projecting direction of the radiation source 22 and the thickness of the object.

The radiation source control portion 27 first moves the radiation source 22 to a reference position to project radiation in a reference direction and obtains a reference attenuation by which the radiation projected by the radiation source 22 is attenuated due to passing through the object.

Though the radiation source 22 projects radiation in different directions onto the mamma M on the photographing table 24 from each of the projecting positions S1, S2, . . . , SN while arcuately moving, the distance by which the radiation is passed through the object increases and attenuation of radiation increases as the direction in which the radiation source 22 projects radiation onto the object inclines with respect to the normal of the upper surface of the photographing table 24 (or the detecting surface of the flat panel detector 241).

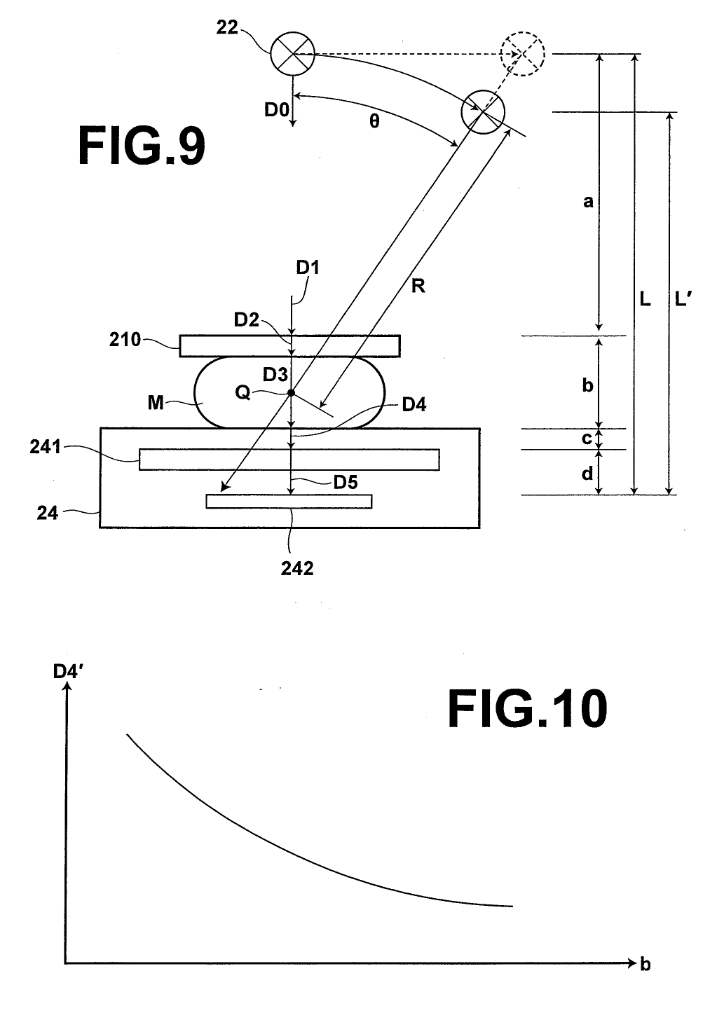

The relation between the attenuation of radiation and the projecting direction in which the radiation is projected from the radiation source will be discussed, hereinbelow. The case where the photographing is carried out while moving the radiation source 22 in parallel to the upper surface of the photographing table 24 will be first discussed, hereinbelow. As shown in FIG. 9, it is assumed that the distance between the radiation source 22 and the pressure plate 210 is a, the thickness of the mamma M is b, the distance between the upper surface of the photographing table 24 and the flat panel detector 241 is c, the distance between the flat panel detector 241 and the AEC sensor 242 is d and the amount of radiation projected by the radiation source 22 is D0.

Here, when the radiation source 22 projects radiation in a direction inclined by Θ to the direction of the normal of the upper surface of the photographing table 24, the radiation D1 which reaches the upper surface of the pressure plate 210 is as represented by the following formula (1).

D1=α×D0/a(θ)² (1)

wherein a(θ)=a/cos θ, and α represents a distance attenuation coefficient.

Further, the radiation D2 which reaches the surface of the mamma M when the radiation D1 reaches the upper surface of the pressure plate 210 is as represented by the following formula (2).

D2=β(θ)×D1 (2)

wherein β(θ) represents the transmittivity of the pressure plate 210.

The radiation D3 which passes through the mamma M and reaches the upper surface of the photographing table 24 when the radiation D2 reaches the surface of the mamma M is as represented by the following formula (3).

$$D 3 = D 2 \times {exp}^{- λ b ( θ )} \times \frac{{a ( θ )}^{2}}{( {a ( θ + b ( θ ) )}^{2}} \qquad ( 3 )$$

wherein b(θ)=b/cos θ and λ represents transmittivity of the mamma M.

The radiation D4 which passes through the photographing table 24 and reaches the upper surface of the flat panel detector 241 when the radiation D3 reaches the upper surface of the photographing table 24 is as represented by the following formula (4).

$$D 4 = γ ( θ ) \times D 3 \times \frac{{( a ( θ ) + b ( θ ) )}^{2}}{( {a ( θ + b ( θ ) + c ( θ ) )}^{2}} \qquad ( 4 )$$

wherein c(θ)=c/cos θ and γ(θ) represents transmittivity of the photographing table 24.

The radiation D5 which passes through the flat panel detector 241 and reaches the AEC sensor 242 when the radiation D4 reaches the upper surface of the flat panel detector 241 is as represented by the following formula (5).

$$\begin{matrix}D 5 = ω ( θ ) \times D 4 \times \frac{{( a ( θ ) + b ( θ ) + c ( θ ) )}^{2}}{( {a ( θ + b ( θ ) + c ( θ ) + d ( θ ) )}^{2}} \\ = α ( θ ) \times β ( θ ) \times γ ( θ ) \times ω ( θ ) \times {exp}^{- λ b ( θ )} \times D 0 / {L ( θ )}^{2}\end{matrix} \qquad ( 5 )$$

wherein L(θ)=a(θ)+b(θ)+c(θ)+d(θ)=L/cos θ

ω(θ) represents the transmittivity of the flat panel detector 241.

When the radiation source 22 is arcuately moved about a projecting point Q, the radiation D5′ which reaches the AEC sensor 242 is corrected as follows by the use of distance L′ between the radiation source 22 and the flat panel detector 241 as shown in FIG. 3. As shown in FIG. 9, when the distance between the radiation source 22 arcuately moved about a projecting point Q and the projecting point Q is assumed R, the distance L′ between the radiation source 22 and the flat panel detector 241 is represented as the following formula (6).

L′=L(θ)+R(1−1/cos θ) (6)

Accordingly, when the radiation source 22 is arcuately move d about a projecting point Q, the radiation D5′ which reaches the AEC sensor 242 is represented by the following formula (7).

$$\begin{matrix}D {5}^{′} = D 5 \times \frac{{L ( θ )}^{2}}{{( L / cos ( θ ) + R ( 1 - cos ( θ ) ) )}^{2}} \\ = α \times β ( θ ) \times γ ( θ ) \times ω ( θ ) \times {exp}^{- λ b ( θ )} \times D 0 / {L ( θ )}^{2} \times \\ \frac{{L ( θ )}^{2}}{{( L / cos ( θ ) + R ( 1 - cos ( θ ) ) )}^{2}}\end{matrix} \qquad ( 7 )$$

The α, β(θ), γ(θ) and ω(θ) are known values governed by the systems. Further, D0 is the amount of radiation projected by the radiation source 22, and D5′ is the amount of radiation as detected by the AEC sensor 242. When the values of the amount of radiation D0 projected in the reference direction by the radiation source 22 when it is in the reference position, the amount of radiation D5 as detected by the AEC sensor 242, the α, β(θ), γ(θ) and ω(θ) are substituted in the formula, the coefficient λ can be obtained. For example, when the position of the radiation source 22 on the line extending toward the normal of the upper surface of the photographing table 24 passing through the center of the mamma M on the photographing table 24 is assumed to be the reference position (that is, the direction in which θ=0 is taken as the reference direction), the formula (7) is converted as the following formula (8).

D5_{θ=0}=D5′_{θ=0}=α×β(0)×λ(0)×ω(0)×exp^{-λb}D0/L² (8)

The coefficient λ is obtained by substituting the values of the amount of radiation D0 projected in the reference direction by the radiation source 22 when θ=0, the amount of radiation D5 as detected by the AEC sensor 242, the α, β(θ), γ(θ) and ω(θ).

The radiation projection amount control means 272 is preferred to control the amount of radiation D0 projected by the radiation source 22 to be uniform according to each of the projecting positions S1, S2, . . . , SN.

When the radiation source 22 is arcuately moved about a projecting point Q, the radiation D4′ which reaches the upper surface of the flat panel detector 241 is as represented by the following formula (9).

$$D {4}^{′} = D 4 \times \frac{{( L ( θ ) - d ( θ ) )}^{2}}{{( L ( θ ) / cos ( θ ) + R ( 1 - cos ( θ ) ) - d ( θ ) )}^{2}} \qquad ( 9 )$$

Therefore the tube voltage and/or the tube current is controlled with the radiation projection amount control means 272 so that D4 of the formula (9) is uniform. When the radiation source 22 is moved in parallel to the upper surface of the photographing table 24, the tube voltage and/or the tube current is controlled so that D4 of the formula (4) is uniform.

In the formula (9), the amount of radiation reaching the upper surface of the flat panel detector 241 attenuates as the θ is largely inclined and the b(θ) increases (that is, the distance by which the radiation is passed through the object.) Accordingly, as the Θ is largely inclined and the distance by which the radiation is passed through the mamma M increases, the amount of radiation projected from the radiation source 22 is increased.

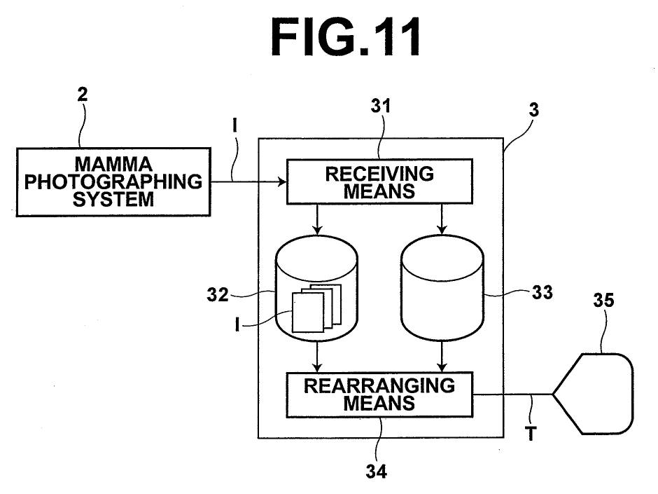

FIG. 11 shows the tomographic radiation image generating system of this embodiment.

The radiation image generating system 3 comprises a receiving means 31 which receives radiation images I photographed by the mamma image taking system 2, a radiation image storage means 32 which stores the radiation images I, a tomographic image rearranging means 34 which rearranges a tomogram T from a plurality of radiation images I, and displaying means 35 which displays the tomogram T.

The radiation image storage means 32 is a large capacity storage means such as a hard disc. In the radiation image storage means 32, a plurality of radiation images photographed by the mamma image taking system 2 while moving the radiation source 22 to each of the projecting positions S1, S2, S3, . . . , Sn.

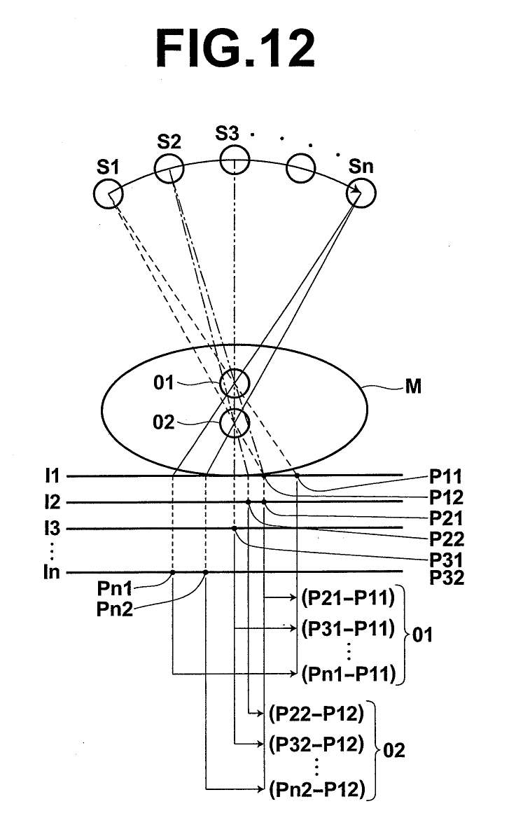

The tomographic image rearranging means 34 generates a tomographic image from a plurality of radiation images I photographed in each of the projecting positions S1, S2, S3, . . . , Sn. As shown in FIG. 12, when radiation is projected

toward the mamma M in different directions while moving the radiation source 22 to each of the projecting positions S1, S2, S3, . . . , Sn, radiation images I1, I2, I3, . . . , In are obtained. For example, when matters (01, 02) in different depths are projected from the position S1 of the radiation source 22, they are projected in positions P11 and P12 on the radiation image I1 while when the matter (01, 02) is projected from the position S2 of the radiation source 22, they are projected in positions P21 and P22 on the radiation image I2. Thus, when radiation is projected toward the mamma M in different directions while moving the radiation source 22 to each of the projecting positions S1, S2, S3, . . . , Sn, the matter 01 is projected in positions P11 and P21, P31, . . . , Pn1 while the matter 02 is projected in positions P12 and P22, P23, . . . , Pn2.

When the cross-section in which the matter 01 exists is to be emphasized, radiation images are added together after the radiation image I2 are moved by P21-P11, the radiation image I3 are moved by P31-P11, . . . and the radiation image In are moved by Pn1-P11. Further, when the cross-section in which the matter 02 exists is to be emphasized, radiation images are added together after the radiation image I2 are moved by P22-P12, the radiation image I3 are moved by P32-P12, . . . and the radiation image In are moved by Pn2-P12. Thus, the tomogram in parallel to a detecting surface of each depth is rearranged by adding together radiation images I1, I2, I3, . . . , In after they are located.

The matter which exists in each depth is different from each other in the position where it is projected on the radiation image I according to the projecting position S1, S2, S3, . . . , or Sn and the projecting direction. Accordingly, the tomographic image rearranging means 34 calculates the amount of movement of the radiation images I1, I2, I3, . . . , In and rearranges the tomographic image.

The flow in which the tomographic image is generated by photographing the images of a mamma M of an object by the use of the tomographic image obtaining system of this embodiment will be described in the concrete, hereinbelow.

In order to photograph the images of the mamma M, the operator inputs the height of the arm according to the height of the object and the rotational angle of the arm according to the shape and/or the size of the mamma M by way of a control portion 28 such as the control panel when the object stands by the tomographic image obtaining system 2 and adjusts the height and the rotational angle of the arm 25 according to the input height and the rotational angle of the arm 25 with the arm moving means 29.

In the case of MLO photographing, the photographing table 24 is inclined by an angle in the range of 45° to 80° from the horizontal so that the photographing table 24 is in parallel to the breast muscle of the object. Normally, the photographing is carried out with the photographing table 24 inclined by 60°. In the case of CC photographing, the photographing table 24 is held in the horizontal and the height is adjusted.

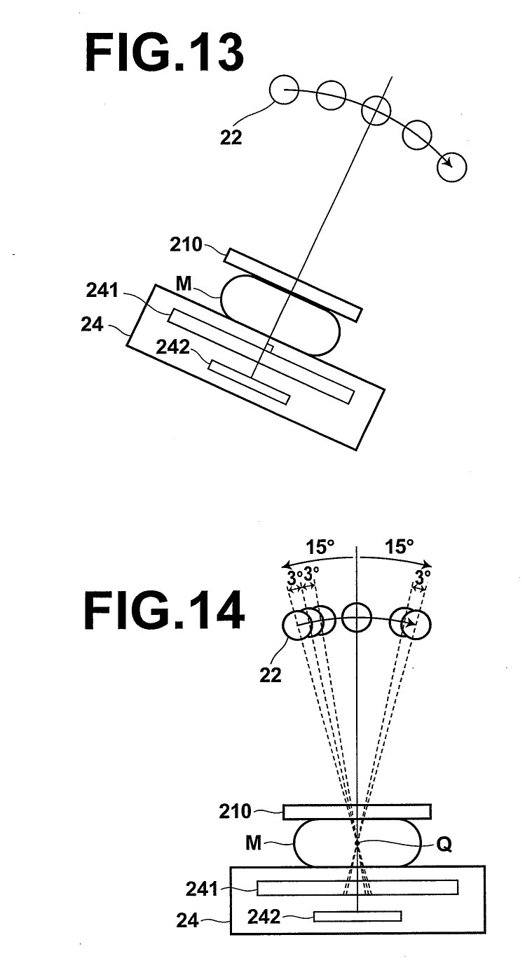

Further, the mamma M is placed on the photographing table 24 so that radiation projected from the radiation source 22 passes the center of the mamma M when θ is 0°. That is, the mamma M is placed so that the radiation source 22 is positioned in the place where passes the center of the mamma M and extends in the direction of the normal from the detecting surface of the radiation detector 241 in the photographing table 24. See FIG. 13.

Since the mamma M is three-dimensional and has a thickness, mammary glands, fats and blood vessels sometimes obstruct the tumor to be photographed when photographed as it is and accordingly, the mamma M is pressed by the pressure plate 210 to be uniformly stretched to a small thickness so that even a shadow of a small induration is clearly photographed with a small amount of radiation upon mammography examination. Accordingly, when the photographing table 24h has been adjusted to a height and an inclination optimal to a photographing, the mamma M is pressed by the pressure plate 210.

When the operator inputs by way of a control portion 28 such as the control panel or the footswitch an instruction to gradually pressurize the mamma M, a pressure plate moving means 252 gradually moves downward the pressure plate 210 in the longitudinal direction of the arm 25 as the input progresses. For example, the mamma M is pressurized to a thickness suitable for the photographing by a pressure incremented by 1 Kg each time the footswitch is depressed. Otherwise, the mamma M may be automatically gradually pressurized to a thickness suitable for the photographing in response to pressure plate 210 being in contact with the mamma M after it is moved downward.

After the pressurization is completed, the radiation source 22 of the radiation containing portion 23 projects radiation to start photographing the mamma M.

In standard mammas M, as shown in FIG. 14, the projecting range is, for instance, ±15° on opposite sides of the line extending center of the mamma M toward a normal and eleven radiation images are taken at intervals of 3°. The amount D0 of radiation to be projected in each position is substantially determined so that the amount of radiation to be projected in the tomosynthesis photographing in total conforms to the amount of radiation to be projected in one photographing for the normal mammography.

First, radiation is projected from the radiation source 22 at the amount D0 of radiation to be projected in the position where the projecting direction is θ=0° and the coefficient λ is calculated from formula (8) by the use of the amount of radiation D5 as detected by the AEC sensor 242 and the amount D0 of radiation projected from the radiation source 22.

The radiation source 22 is moved in sequence to each of the projecting positions S1, S2, . . . , and Sn by a moving means 221. At this time, the radiation projection amount control means 272 controls the amount of radiation projected from the radiation source 22 in each of the projecting position S1, S2, . . . , and Sn so that the radiation D4 reaching the upper surface of the flat panel detector 241 is uniform. Thus, the radiation images I1, I2, I3, . . . , In are obtained by projecting radiation toward the projecting point Q of the mamma M from each of the projecting positions.

The transmission portion 261 transmits the obtained radiation images I1, I2, I3, . . . , In to the tomogram generating system 3. Further, the transmission portion 261 also transmits photographing conditions such as the projecting position S1, S2, . . . , or SN under which the radiation images I1, I2, I3, . . . , In are photographed to the tomogram generating system 3.

The tomogram generating system 3 stores the radiation images I1, I2, I3, . . . , In transmitted by the mamma image taking system 2 in a radiation image storage means 32 with a receiving means 31.

The rearranging means 34 rearranges tomogram of each depth from the radiation images I1, I2, I3, . . . , In according to the projecting position S1, S2, . . . , or Sn in which the radiation images I1, I2, I3, . . . , In has been photographed stored in a photographing condition storage means 33 on the radiation image storage means 32. The display portion 35 displays the rearranged tomogram.

As fully described above, the accuracy of a tomogram can be improved by controlling the amount of radiation reaching the radiation image detector such as the flat panel detector in the projecting positions to be uniform, thereby controlling the density of photographed images to be uniform.

Though the radiation source is arcuately moved when the tomosynthesis is carried out in the above embodiment, the radiation source may be moved in parallel to the upper surface of the photographing table. When the radiation source is to be moved in parallel to the upper surface of the photographing table, the amount of radiation reaching the upper surface of the flat panel detector is represented by formula (4) and the amount of radiation projected from the radiation source is controlled so that the value of D4 is uniformed.

Though the mamma is photographed in the above embodiment, another part of the object may be photographed.

What is claimed is:

1. A radiation tomogram obtaining system comprising
a radiation image detector which detects a radiation image of an object,
a radiation projecting means which is provided to be opposed to the radiation image detector, and to project radiation in a plurality of projecting directions onto the object on the radiation image detector while moving,
a thickness detecting means which detects the thickness of the object,
a radiation amount control means which controls the amount of radiation projected in each of the projecting directions so that the amount of radiation entering the radiation image detector is uniform according to the projecting direction and the thickness of the object.

2. A radiation tomogram obtaining system as defined in claim 1 further comprising a radiation amount detecting means which detects the amount of radiation projected by the radiation projecting means and passed through the object
the radiation amount control means controlling the amount of radiation projected in each of the projecting directions on the basis of the amount of radiation projected by the radiation projecting means in a reference direction, the amount of radiation detected by the radiation amount detecting means when the radiation projecting means projects radiation in the reference direction, and the angle between the reference direction and each of the projecting directions.
